(19) United States
(12) Patent Application Publication
(10) Pub. No.: US 2026/0100319 A1
(43) Pub. Date: Apr. 9, 2026

(54) SYSTEM AND METHOD FOR DETECTING DISCRETE OPEN AND CLOSE STATES OF ELECTRICAL SWITCHING DEVICES

(71) Applicant: EATON INTELLIGENT POWER LIMITED, DUBLIN 4 (IE)

(72) Inventors: Vaibhav Deshmukh, Pune (IN); Paul R. Rakus, Coraopolis, PA (US); Niloy Khatua, Pune (IN)

(73) Assignee: EATON INTELLIGENT POWER LIMITED, DUBLIN 4 (IE)

(21) Appl. No.: 18/907,841

(22) Filed: Oct. 7, 2024

(51) Int. Cl. H01H 9/54; H01H 3/38; H01H 9/02

(52) U.S. Cl. CPC H01H 9/54; H01H 3/38; H01H 9/02

(57) ABSTRACT

An apparatus for use in an electrical switching device including an operating mechanism having an energy storing device, a cam assembly, a pole shaft, and separable contacts. The apparatus includes a holding device; a discharge detector structured to be disposed adjacent to the cam assembly and detect discharging status of the energy storage device based on the position of the cam assembly; a pole shaft position detector structured to be coupled to the pole shaft and detect open and close state of the separable contacts based on the position of the pole shaft; and a switching device monitor coupled to the detectors and structured to receive data from the detectors, analyze the data and perform control and/or diagnostics on the electrical switching device based on the analysis, the data including the detected discharging status and the detected open and close state.

### FIELD OF THE INVENTION

The disclosed concept relates generally to a system and method of circuit protection, and in particular, to a system and method of detecting discrete open and close states in an air circuit breaker.

### BACKGROUND OF THE INVENTION

Electrical switching devices (e.g., without limitation, circuit breakers) are utilized in power distribution systems to protect electrical conductors and equipment against the effects of abnormal current conditions, e.g., without limitation, short circuits, ground faults, overloads or overcurrent conditions. The electrical switching devices utilize an energy storage device in the form of one or more large closing springs to close the contacts of the device. These devices also include an opening spring or springs which rapidly separate the contacts to interrupt current flowing in the power circuit. Either or both of the closing spring and the opening spring can be a single spring or multiple springs.

A stored-energy circuit breaker (e.g., without limitation, an air circuit breaker) is an electrical switching device used in industrial applications. It is an automatically operated electrical switching device that interrupts electrical current using separable contacts to protect an electrical circuit from damage caused by excess current from an abnormal current condition. Its primary function is to interrupt current flow after an abnormal current condition is detected. For closing and opening of the contact structure, an air circuit breaker utilizes an energy storage device. The energy stored in the device is utilized to close the air circuit breaker. Typically, the stored energy in a closing spring is transmitted to a movable contact carrier of the air circuit breaker through a drive cam and drive coupling arrangement. The drive cam having a cam profile with varying radius is rotated by the closing spring. The drive coupling includes a drive roller on a main link connected to a pole shaft of the air circuit breaker. A latch assembly latches the drive roller against the drive cam profile so that rotation of the drive cam by the closing spring results in rotation of the pole shaft, which being connected to the movable contact carrier in each pole, results in closure of the contacts.

To prolong its lifespan and maximize its reliability, it is essential to perform maintenance, control and/or diagnostics of the air circuit breakers. For accurate diagnostics, analyzing closing and opening time and identifying the discrete full closed position of the circuit breakers are particularly important. For example, the making current release (MCR) applications are utilized to prevent the circuit breakers from stalling while closing on a fault current that exceeds the breakers' capacity to fully close. The MCR is a self-protection feature employed by many modern power circuit breakers and structured to cause the circuit breakers to trip immediately upon detecting a large fault current exceeding a “close and latch” threshold for the circuit breakers. That is, the MCR function is used to release a trip latch (i.e., open the circuit breaker) when a high current (exceeding the level that the closing spring was designed to be capable of overcoming to fully close the breaker mechanism) is detected and the breaker mechanism is not already closed. This prevents stalling during closing on these high currents that would require more closing energy (force) than the closing spring can store. As such, in performing the MCR, the identification of the full close state and the precise timing thereof are critical in differentiating “closing on fault” and “fault occurs after close” condition.

While a simple full closed detection switch was sufficient to detect the fully closed position of some types of air circuit breakers (having, e.g., without limitation, over-toggle type mechanisms), such a simple full closed detection switch cannot identify discrete closed positions of the air circuit breakers that utilize under-toggle mechanisms. In circuit breakers with the under-toggle mechanism, it is exceedingly difficult to identify the full close state based on detecting the rotation of the pole shaft since the rotation varies significantly due to a variety of factors, especially elasticity in the components and assemblies of the breaker mechanism. To account for the variation, a time delay switch is traditionally utilized instead of a simple pole shaft position sensor to identify the near close position of the circuit breakers and to control MCR activation. However, the time delay switch indicates the full close state of the circuit breakers after several milliseconds from the actual full close. Based on that signal from the time delay switch, the electronic trip unit would detect high current flowing through the circuit breaker, which is not yet fully closed in reality. Upon detecting the high current, the MCR circuit is triggered and an electronic trip unit issues a trip command, disrupting the power distribution. Further, inaccurate determination of discrete open and/or closed positions of breaker contacts results in inaccurate diagnostics of breaker health, thereby potentially leading to catastrophic malfunction.

There is room for improvement in monitoring the health of electrical switching devices, and in particular in identifying the full close state of the electrical switching devices and the precise timing thereof.

### SUMMARY OF THE INVENTION

These needs, and others, are met by an apparatus for use in an electrical switching device including an operating mechanism having an energy storage device, a cam assembly, a pole shaft coupled to the cam assembly, and separable contacts coupled to the pole shaft. The apparatus includes: a holding device structured to be attached to the operating mechanism of the electrical switching device; a discharge detector affixed to the holding device and structured to be disposed adjacent to the cam assembly and detect discharging status of the energy storage device based on the position of the cam assembly; a pole shaft position detector affixed to the holding device and structured to be coupled to the pole shaft and detect the open and close state of the separable contacts based on the position of the pole shaft; and a switching device monitor coupled to the discharge detector and the pole shaft position detector, the switching device monitor structured to receive data from the detectors, analyze the data and perform diagnostics and control of the electrical switching device based on the analysis, the data including the detected discharging status of the energy storage device and the detected open and close state of the separable contacts.

Another example embodiment includes an electrical switching device structured to connect a power source and loads. The electrical switching device includes a housing; a charging assembly; an electrical trip unit (ETU) structured to interrupt current from flowing to the loads in an abnormal current condition; an operating mechanism coupled to the charging assembly and the ETU, the operating mechanism including an energy storage device, a cam assembly, a pole shaft coupled to the cam assembly, and separable contacts having a movable contact coupled to the loads and a fixed contact coupled to the power source; and a full close position monitor including: a holding device structured to be attached to the operating mechanism of the electrical switching device; a discharge detector affixed to the holding device and structured to be disposed adjacent to the cam assembly and detect discharging status of the energy storage device based on position of the cam assembly; a pole shaft position detector affixed to the holding device and structured to be coupled to the pole shaft and detect open and close state of the separable contacts based on the position of the pole shaft; and a switching device monitor disposed within the ETU and coupled to the discharge detector and the pole shaft position detector, the switching device monitor structured to receive data from the detectors, analyze the data and perform control and/or health diagnostics of the electrical switching device based on the analysis, the data including the detected discharging status of the energy storage device and the detected open and close state of the separable contacts.

Yet another example embodiment provides a method of protecting an electrical switching device. The electrical switching device includes an operating mechanism having an energy storage device, a cam assembly, a pole shaft coupled to the cam assembly, and separable contacts coupled to the pole shaft. The method includes detecting discharging status of the energy storage device based on position of the cam assembly, detecting open and close state of the separable contacts based on a position of the pole shaft, and analyzing data including the detected discharging status of the energy storage device and the detected open and close state of the separable contacts.

### BRIEF DESCRIPTION OF THE DRAWINGS

A full understanding of the invention can be gained from the following description of the preferred embodiments when read in conjunction with the accompanying drawings in which:

FIG. 1 is a perspective view of an exemplary electrical switching device in accordance with a non-limiting, exemplary embodiment of the disclosed concept;

FIG. 2 is a perspective view of the interior of the exemplary electrical switching device of FIG. 1;

FIG. 3 is a partial block diagram of the exemplary electrical switching device including an exemplary apparatus in accordance with a non-limiting, exemplary embodiment of the disclosed concept;

FIGS. 4-6 illustrate various state of the exemplary electrical switching device of FIG. 1;

FIGS. 7-9 illustrate a sequence of charging and discharging of an energy storage device of the operating mechanism of the exemplary electrical switching device of FIG. 1;

FIGS. 10-12 illustrate the exemplary apparatus of FIG. 3; and

FIG. 13 illustrates an exemplary logic sequence generated by the exemplary apparatus.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

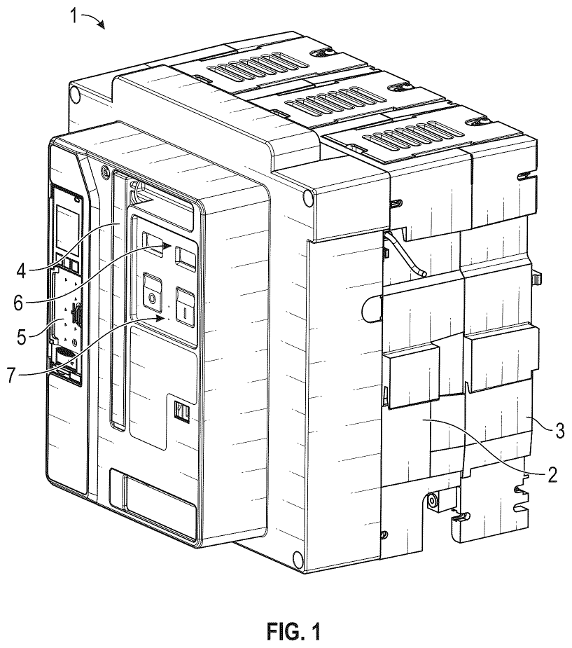

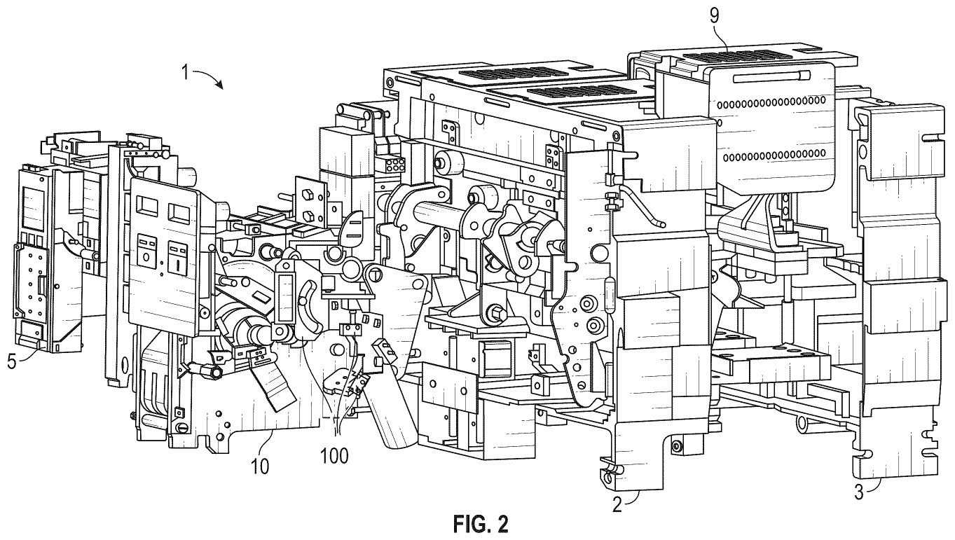

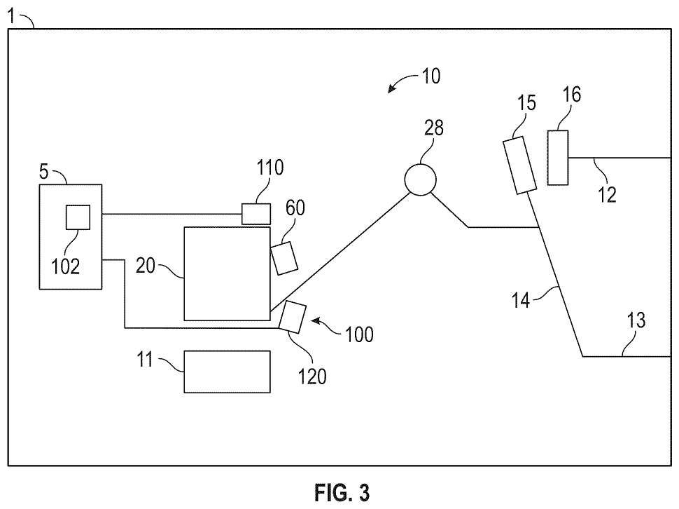

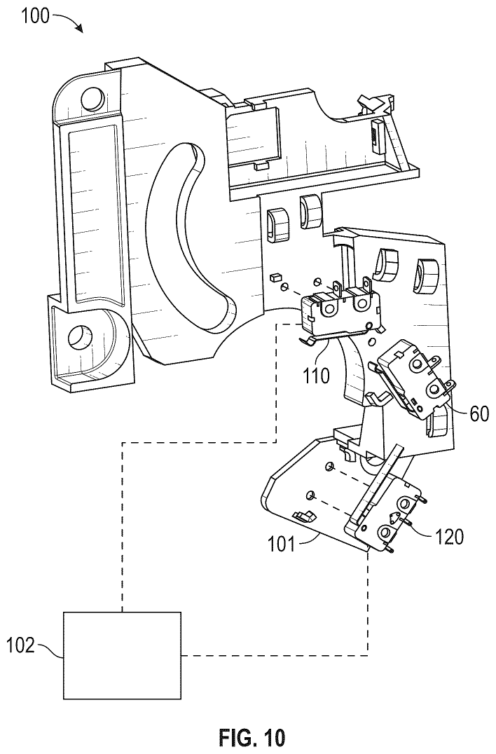

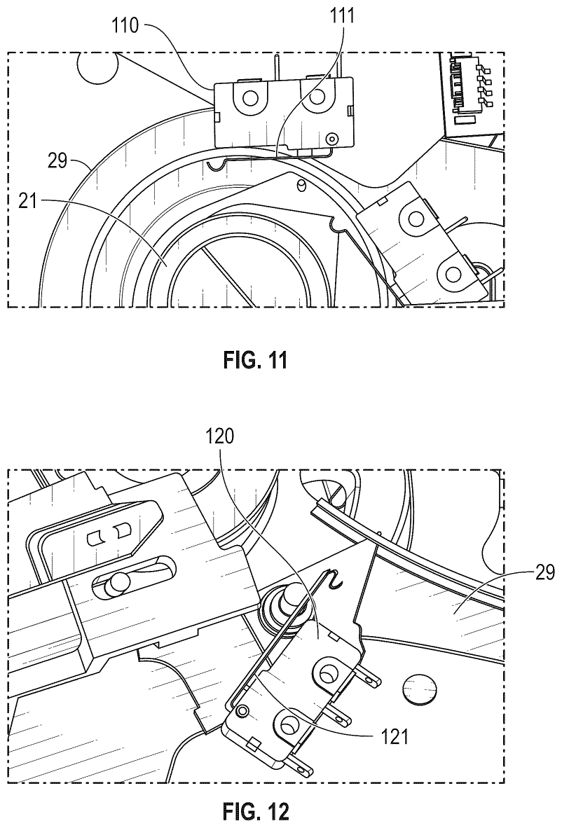

FIGS. 1-13 illustrate an electrical switching device (e.g., without limitation, an air circuit breaker) 1 and/or an apparatus 100 in accordance with a non-limiting, example embodiment of the disclosed concept. As shown in FIGS. 1 and 2, the air circuit breaker 1 includes a front housing 2, a rear housing 3, a charging handle 4, an electronic trip unit (ETU) 5, spring and contact status indicators 6, close and open breaker buttons 7, and an arc chute assembly 9. The air circuit breaker 1 may have three or four poles, each pole having an arc chamber (not shown). As shown in FIG. 2, the air circuit breaker 1 includes an operating mechanism 10 disposed within the front housing 2. The operating mechanism 10 includes an energy storage device, e.g., without limitation, one or more closing springs 11 (see FIGS. 3, 7-12) structured to be charged to store energy for closing the air circuit breaker 1. The closing spring 11 is charged by operation of the charging handle 4 or remotely by a motor operator (not shown). The term “charging” herein refers to storing mechanical energy by compressing or extending the closing spring 11 in preparation of closing the air circuit breaker 1. For charging, the user begins by pulling a charging handle 4, e.g., without limitation, 5-10 times, or a motor having a ratchet may be activated to drive the closing spring 11. The compressed spring 11 then stores the energy in preparation for closing of separable contacts of the air circuit breaker 1. The ETU 5 actuates the operating mechanism 10 to open all of the poles of the circuit breaker through rotation of a pole shaft 28 (see FIGS. 7-9) in response to predetermined characteristics of the current flowing through the circuit breaker 1. The spring and contact status indicators 6 indicate the status (discharged or charged) of the closing spring 11 and status (open or close) of the contacts 15,16. Further, the operating mechanism 10 includes an exemplary novel apparatus 100 discussed further with reference to FIGS. 10-13.

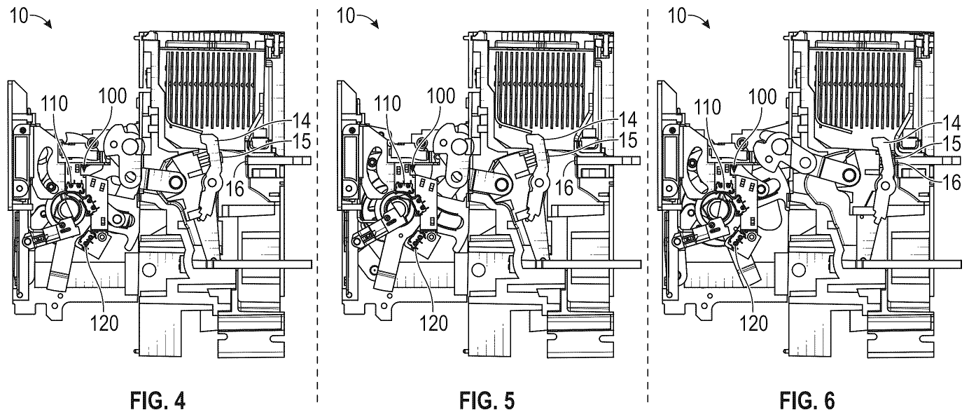

FIG. 3 is a partial block diagram of the air circuit breaker 1 in accordance with the non-limiting, example embodiment of the disclosed concept. The operating mechanism 10 includes a closing spring 11, a cam assembly 20, an apparatus 100, a pole shaft 28, a moving contact carrier 14 having a movable contact 15 and coupled to the pole shaft 28 and a load conductor 13, and a fixed contact 16 coupled to a line conductor 12. The moving contact carrier 14 is rotated between the open and closed position to open and close the separable contacts 15,16 by the operating mechanism 10 as shown in FIGS. 4-6. In closing operation, the moving contact carrier 14 of the air circuit breaker 1 moves the moving contact 15 to make contact with the fixed contact 16. As such, the term “closing” herein refers to releasing the stored energy to drive the contacts 15, 16 to close rapidly (e.g., without limitation, 20-30 ms). The basic functionalities of the air circuit breaker 1 including the closing and opening of the contacts 15,16 and the charging and discharging of the closing spring 11 are discussed with reference to FIGS. 4-9.

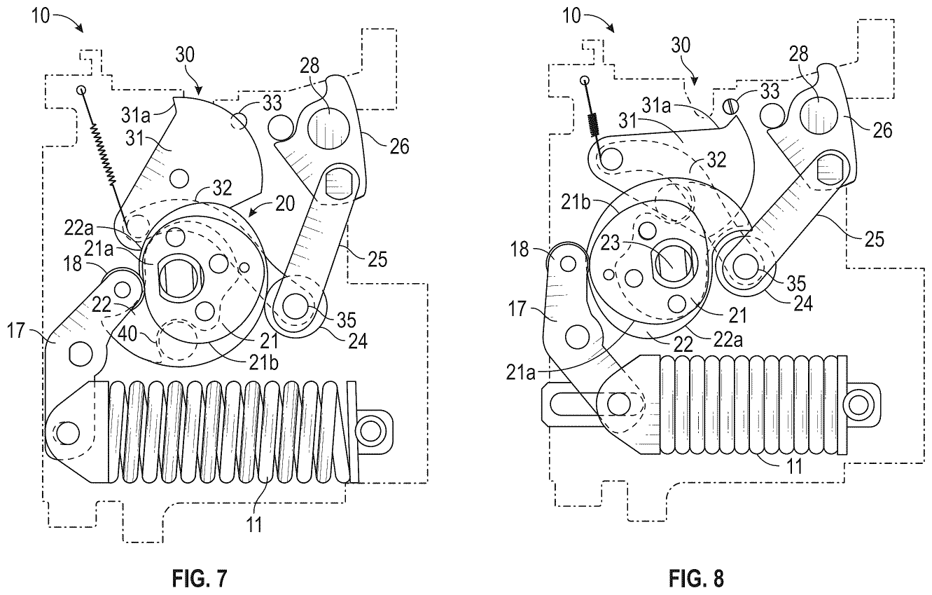

In FIG. 4, the air circuit breaker 1 is in an open and discharged mode in which the contacts 15,16 are open and the closing spring 11 (not shown in FIGS. 4-6) has been discharged. In FIG. 5, the air circuit breaker 1 is in an open and charged mode in which the contacts 15,16 remain open, but the closing spring 11 is charged. In FIG. 6, the air circuit breaker 1 is in a closed and discharged mode in which the contacts 15,16 are closed and the closing spring 11 is discharged.

FIGS. 7-9 illustrate the sequence of charging and discharging the closing spring 11. As shown in these figures, the closing spring 11 is fixed at one end and coupled to a rocker 17. The operating mechanism 10 further includes the cam assembly 20. The cam assembly includes a cam shaft 23, a charging cam 21 and a drive cam 22. The cam assembly 20 is, e.g., without limitation, a 360° mechanism which compresses the closing spring 11 to store energy during part of the rotation, and which is rotated by release of the energy stored in the closing spring 11 during the remainder of the rotation. This is accomplished through engagement of the charging cam 21 by a rocker roller 18. A preload on the closing spring 11 maintains the rocker roller 18 in engagement with the charging cam 21, which has a charging portion 21a and a closing (non-charging) portion 21b. The charging portion 21a increases in diameter with counterclockwise rotation of the charging cam 21 at the point of engagement with the rocker roller 18. The closing portion 21b decreases in diameter as the charging cam 21 rotates against the rocker roller 18 and the spring 11 drives the charging cam 21 counterclockwise when a latching mechanism (e.g., a stop roller 40) is released. The charging portion 21a is configured so that a substantially constant torque is required to compress the closing spring 11. The drive cam 22 includes a cam profile 22a, which in certain rotational positions is engaged by a drive roller 24 mounted on a main link 25, which in turn is pivotally connected to a drive arm 26 on the pole shaft 28 for closing the stored-energy circuit breaker 1 when constrained by a trip mechanism 30. The trip mechanism 30 includes a hatchet 31 and a hatchet link (also known as a banana link) 32 connected to the hatchet 31 at one end and pivotally connected to a roller pin 35 at the other end. The hatchet 31 includes a latch edge 31a, which engages a trip D shaft 33 (also referred to as a trip D latch herein) when the trip D shaft 33 is rotated to a latched position. With the hatchet 31 latched, the hatchet link 32 holds the drive roller 24 in engagement with the drive cam 22. In operation, the ETU 5 actuates the breaker 1 to open by rotating the trip D shaft 33 to a trip position so that the latch edge 31a slides off the trip D shaft 33 and the hatchet 31 passes through a notch in the trip D shaft 33, which repositions the pivot point of the hatchet link 32 connected to the hatchet 31 and allows the drive roller 24 to float independently of the drive cam 22. Examples of air circuit breakers are described further in detail in U.S. Pat. Nos. 6,437,269 and 6,066,821.

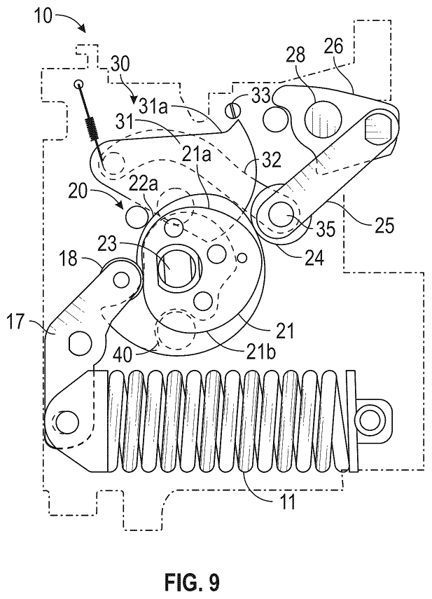

FIG. 7 shows an open and discharged mode in which the closing spring 11 is discharged and the contacts 15,16 are open. In this position, the drive cam 22 is positioned so that the charging cam 21 has its smallest radius in contact with the rocker roller 18. Thus, the rocker 17 is rotated to a full clockwise position and the closing spring 11 is at its maximum extension. Further, the trip mechanism 30 is not latched so that the drive roller 24 is floating although resting against the drive cam 22. For charging, the cam shaft 23 is rotated counterclockwise manually by the handle 4 or through operation of the charge motor. As the cam shaft 23 rotates, the charging portion 21a of the charging cam 21 progressively increases in diameter, engages the rocker roller 18, and rotates the rocker 17 clockwise to compress the closing spring 11. Until the end of charging of the spring 11, the driver roller 24 is in contact with a portion of the drive cam 22, which has a constant radius, so that the drive roller 24 continues to float. FIG. 8 shows an open and charged position in which the closing spring 11 is fully charged and ready to close the separable contacts 15,16. Upon releasing the stop roller 40 by a close prop (not shown), the spring energy is released to rotate the charging cam 21 to the position in the closed and discharged mode as shown in FIG. 9. As the charging cam 21 is rotated by spring force transferred through the rocker 17, the drive roller 24 is engaged by the cam profile 22a of the second drive cam 22. The radius of the cam profile 22a increases with cam shaft rotation and since the hatchet link 32 holds the drive roller 24 intact with this surface, the pole shaft 28 is rotated to close the contacts 15,16. At this point the hatchet ledge 31a engages the trip D latch 33 and the separable contacts 15,16 are latched closed, i.e., in the full close position. If the air circuit breaker 1 is tripped at this point by rotation of the trip D shaft 33 so that the hatchet ledge 31a is disengaged from the trip D shaft 33, the very large force generated by the compressed contact springs (not shown) exerted through the main link 25 pulls the pivot point of the hatchet link 32 on the hatchet 31 downward and drive roller 24 drops free of the drive cam 24 allowing the pole shaft 28 to rotate and the contacts 15,16 to open (back to the open discharged position shown in FIG. 7).

As previously mentioned, the full close state is the position at which the contact springs (not shown) are fully compressed and the air circuit breaker 1 would withstand the desired current for which it is designed. Identifying the moment when the breaker mechanism reached the full close state of the separable contacts 15,16 is essential in accurately monitoring and/or diagnosing the health of the air circuit breaker 1. However, as the closing spring 11 is discharged, the contacts 15,16 may touch, but be stalled before reaching the full close position. Further, the position of the pole shaft 28 may vary at full closed due to, e.g., without limitation, elasticity and friction, wear and tear, environmental factors, etc. As such, identifying the full close state and determining the precise timing of the full close becomes difficult. Despite numerous efforts to determine the full close state and its precise timing, these efforts have been unfruitful, and, in fact, useless due to the variations in the closing positions of the pole shafts, which have made measuring the precise timing of the full close state nearly impossible. The exemplary novel apparatus 100, however, resolves these problems and allows the identification of the full close state and measurement of the precise time of the opening and closing of the contacts 15,16 by use of both a discharge detector 110 and a pole shaft position detector 120. The apparatus 100 is described with reference to FIGS. 10-12.

FIG. 10 illustrates an apparatus 100 in accordance with a non-limiting, exemplary embodiment of the disclosed concept. The apparatus 100 is structured to control and/or monitor the air circuit breaker 1 and includes a holding device 101, a switching device monitor 102, a discharge detector 110 and a pole shaft position detector 120. The holding device 101 is affixed to a portion of the operating mechanism 10 including the closing spring 11, the cam assembly 20, the pole shaft 28 and any relevant link components thereof. While FIGS. 2, 4-6 and 10-12 show that the discharge detector 110 and the pole shaft position detector 120 are microswitches, this is for illustrative purposes only, and thus the detectors 110,120 may be any type of appropriate sensing devices (e.g., without limitation, switches, sensors, semiconductor devices including optocoupler) without departing from the scope of the disclosed concept. The switching device monitor 102 may be, e.g., without limitation, software or firmware structured to receive detection data from the discharge detector 110 and the pole shaft position detector 120, analyze the data, perform diagnostics and transmit an alert to a user based on diagnosis. Further, the switching device monitor 102 is structured to perform control functions including MCR (making current release) function without requiring a separate MCR device to be installed within the air circuit breaker 1. Based on the detection data inputted from each detector 110,120, the switching device monitor 102 is structured to determine the instantaneous state of the air circuit breaker 1. The switching device monitor 102 may be a standalone device for use in diagnostics and/or control, measures timing (e.g., without limitation, closing timing, overall speed, etc.) for performance-based device heath monitoring as shown in FIG. 10, or may be embedded, downloaded, or installed in another controller such as the ETU 5 as shown in FIG. 3.

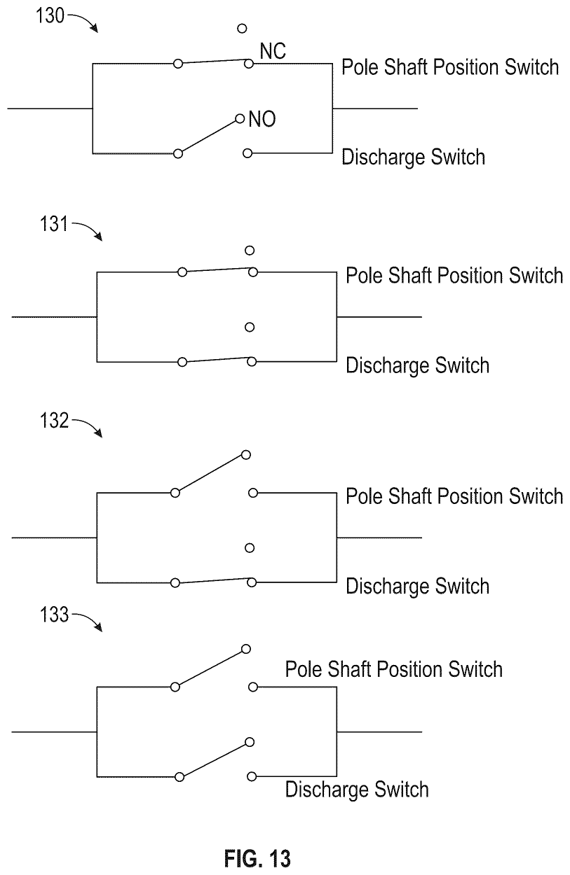

The discharge detector 110 is disposed adjacent to the charging cam 21 and structured to detect the full discharged state of the closing spring 11. The discharge detector 110 includes a lever 111 structured to be actuated by the charging cam 21. The pole shaft position detector 120 is disposed adjacent to a pole shaft driving link 29 coupled to the pole shaft 28 and structured to detect the closing of the contacts 15,16. It has a lever 121 structured to be actuated by the pole shaft driving link 29 when the pole shaft 28 reaches the approximate angle where the contacts 15,16 make the first contact (when the contacts 15,16 touch but are not fully closed). While FIG. 13 and Table 1 illustrate the detectors 110,120 each including switches and the switches 110,120 being connected in parallel to one input on the switching device monitor 102, it is to be understood that this is for illustrative purposes only, and thus any other appropriate schemes or mechanisms can be utilized without departing from the scope of the disclosed concept. For example, the detectors 110,120 may be wired into the switching device monitor 102 independently. In another example, the switches 110,120 may have the opposite state and be wired in series into one input to the monitor 102. In this alternate example, the air circuit breaker 1 is fully closed only when the series-wired detector circuit is closed.

In operation, a charging switch 60 is driven by its own dedicated charging switch cam (not shown) on the cam assembly 20 that is coupled to the charging cam 21, and this charging switch actuates the charging switch 60, and then the apparatus 100 reaches the fully charged state. The charging cam 21 has a profile including the charging portion 21a and when it is fully charged the charging portion 21a is substantially adjacent to the charging switch 60. Upon releasing of the stop roller 40, the cam assembly 20 is free to rotate and release the energy from the closing spring 11. The drive roller 24 engages the drive cam 22, and as the cam shaft 23 rotates, the radius of the drive cam 22 increases, which causes the pole shaft 28 to rotate to close the contacts 15,16. During the closing of the contacts 15,16, the charging cam 21 actuates the charging switch 60, which in turn begins the measurements of contact closing time. When the first touch of the contacts (i.e., the first contact) 15,16 occurs, the closing spring 11 does not discharge its energy to the full extent. Thus, after the first contact, the closing spring 11 still has stored energy to enable compressing the contact springs. Further, upon the first contact, the pole shaft position detector 120 is actuated. When the cam shaft 23 is fully rotated (360°) and thus fully discharged, the circuit breaker 1 is fully capable of withstanding the designed current and the contacts 15,16 are now in the full close position. Thus, the detection of the full close and precise timing of the full close is achieved by the inputs from both of the discharge detector 110 and the pole shaft position detector 120 to the switching device monitor 102.

The inputs from the detectors 110,120 include, e.g., without limitation, binary outputs (0 and 1) if the detectors 110,120 comprise switches and the switches 110,120 are connected in parallel as illustrated in FIG. 13 and Table 1. The binary output 0 indicates that the respective switch is open (in the open-circuit state), and 1 indicates that the respective switch circuit is closed (in the closed-circuit state). For example, the discharge detector 110 is in the closed-circuit state (1) when the closing spring 11 is being discharged by rotation of the charging cam 21 and in the open-circuit state (0) when the closing spring 11 is fully discharged and the charging cam 21 has completed the rotation. The pole shaft position detector 120 is in the closed-circuit state (1) when the separable contacts 15,16 are open via the pole shaft 28 and in the open-circuit state (0) when the separable contacts 15,16 are touching and/or fully closed via the pole shaft 28.

In this exemplary embodiment, only when both switches 110,120 are open, the switching device monitor 102 receives an open input signal (0) indicating that the circuit breaker 1 has reached the full close state (fully-closed position). If one or both detectors 110,120 are closed, a closed input signal (1) is provided to indicate that the breaker mechanism is not fully closed. Thus, the switching device monitor 102 determines that the full close state is reached only if the contacts 15,16 are fully closed and the closing spring 11 is fully discharged. This is important in that the apparatus 100 utilizes both detectors 110,120 simultaneously to accurately detect the full close state of the circuit breaker 1, which is not possible under the existing close state detectors or systems that use only a pole shaft position sensor. That is, when the contacts 15,16 first touch, the drive roller 24 is still on the increasing-radius portion 22a of the drive cam 22 because the pole shaft 28 still needs to travel further to compress the contact springs (not shown). This means that a very high force from the contacts 15,16 (such as the electromagnetic force that appears when a high current starts to flow) is capable of stopping the closing under some extreme circumstances and even reversing the direction of the cam shaft 23, and thus potentially putting energy back into the closing spring 11. This stalling or reversing causes problems and is undesirable in some modes of operation. Thus, the fully stable, full-closed position is not considered to be achieved until the drive roller 24 has reached the constant radius portion of the drive cam 22, which coincides with the closing spring being fully discharged. Therefore, using the pole shaft position detector 120 alone as the existing close state detectors or systems do cannot provide an accurate detection of the full close state. Further, utilizing both detectors 110,120 also averts any issues resulting from using only the discharge detector 110. This is because the cam assembly 20 and the cam shaft 23 can be in the same fully discharged position both before the air circuit breaker 1 opens and also after the breaker 1 opens by releasing the trip mechanism 30 (e.g., the trip D latch 33). Thus, the discharge detector 110 alone cannot accurately detect the full close state of the circuit breaker 1 since it cannot differentiate whether the circuit breaker 1 is in the fully closed state or the open and discharged state. By using the pole shaft position detector 120 in addition to the discharge detector 110, the apparatus 100 is able to identify the difference between the fully closed state and the open and discharged state when the discharge detector 110 detects the cam assembly 20/cam shaft 23 to be in the fully discharged position.

Accordingly, under the disclosed concept, the full close state is defined and detected as the state in which the pole shaft 28 is beyond the point of contact touch and the cam shaft 23 is rotated far enough to put the roller 24 on the constant radius section of the drive cam 22. By detecting the full close state and the precise timing of reaching the full close state, the apparatus 100 provides accurate monitoring of the state of the air circuit breaker 1. For example, the exact moment of reaching the full close state (when the cam shaft 23 reaches the angle of full discharge and the drive roller 24 is on the constant radius) provides a useful precisely-defined end point to the closing time measurement for device health and diagnostics. Further, achieving the full close state provides useful confirmation of successfully reaching the stable position that can withstand the full designed current level. Hence, if the breaker 1 does not reach the full close state in the time interval expected, it can be expected that the breaker mechanism may stall and will not achieve the full current withstand capability. In such scenario, the ETU 5 may need to initiate circuit breaker opening (releasing the trip mechanism 30) to return to the safe open position in order to avoid undesirable consequences.

Referring back to the figures, FIG. 13 illustrates four states of the air circuit breaker 1 where the detectors 110,120 are switches connected in parallel. In the open and charged state 130, the pole shaft position detector 120 is in the closed-circuit state (1) and the discharge detector 110 is in the open-circuit state (0). In this state, the contacts 15,16 are open and the closing spring 11 is charged. In the early state 131 of closing, the pole shaft position detector 120 is in the closed-circuit state (1) and the discharge detector 110 is also in the closed-circuit state (1). Thus, the contacts 15,16 are closing and the closing spring 11 is being discharged. In the last state 132 of closing, the pole shaft position detector 120 is in the open-circuit state (0) and the discharge detector 110 is in the closed-circuit state (1). In this state, the first contact has occurred, and thus the pole shaft position detector 120 is now open. Further, the closing spring 11 is being discharged, but still has stored energy. Thus, the discharge detector 110 remains closed. In the full close state 133, the pole shaft detector 120 is in the open-circuit state (0) and the discharge detector 110 is in the open-circuit state (0). In this state, the making current release (MCR) circuit (not shown) is turned OFF. Further, the pole shaft position detection 120 remains open and the discharge detector 110 is now open since the cam shaft 23 has completed its 360° rotation and the closing spring 11 is fully discharged.

Table 1 illustrates the four states of the circuit breaker 1 as shown in FIG. 13. In the open and charged state, the pole shaft position detector 120 and the discharge detector 110 provide input signals 1, 0, respectively, to the switching device monitor 102. The switching device monitor 102, in turn, returns logic outcome 1, indicating that the breaker mechanism is open. In the early state of closing, the pole shaft position detector 120 and the discharge detector 110 provide input signals 1, 1, respectively, to the switching device monitor 102. The switching device monitor 102, in turn, returns logic outcome 1, indicating that the breaker mechanism is not fully closed. In the last state of closing, the pole shaft position detector 120 and the discharge detector 110 provide input signals 0, 1, respectively, to the switching device monitor 102. The switching device monitor 102, in turn, returns logic outcome 1, indicating that the breaker mechanism is not fully closed. Finally, when the breaker mechanism has reached the full close state, the pole shaft position detector 120 and the discharge detector 110 provide input signals 0, 0, respectively, to the switching device monitor 102. Only then, the switching device monitor 102 returns logic outcome 0, indicating that the breaker mechanism is fully closed.

TABLE 1

| | Pole Shaft | | Logic for Detectors |
|---|---|---|---|
| Breaker | Position | Discharge | Connected in Parallel (FIG. |
| State | Detector | Detector | 13) |
| Open and | 1 | 0 | 1 |
| Charged | | | |
| State | | | |
| Early | 1 | 1 | 1 |
| State of | | | |
| Closing | | | |
| Last State | 0 | 1 | 1 |
| of Closing | | | |
| Full Close | 0 | 0 | 0 |
| State | | | |

Therefore, as mentioned previously, by utilizing both pole shaft position detector 120 and discharge detector 110, the exemplary apparatus 100 in accordance with the disclosed concept identifies the discrete full close state and the precise timing of reaching the full close state of the air circuit breaker 1 unlike the existing close position detectors or systems that can provide neither the identification of the discrete full close position nor the precise timing of the full close by the circuit breakers. As a result, the switching device monitor 102 can analyze the input data from the detectors 110,120 and provide accurate and reliable diagnostics of the health of the air circuit breaker 1. For example, if the manufacturer's specification indicates that the acceptable closing time to reach the full close position is, e.g., without limitation, 29 ms, but the measured closing time is, e.g., without limitation, 35 ms, then the switching device monitor 102 can determine that the air circuit breaker 1 needs an inspection and transmit an alert to the user, stating that the measured closing time is slower than the baseline threshold (e.g., without limitation, 33 ms), and service is needed for the air circuit breaker 1. In another example, if there is a trend in gradual increase in closing time based on the precise closing times measured over a period (e.g., without limitation, 6 months, 1 year, etc.), the switching device monitor 102 can determine that the air circuit breaker 1 may have wear and tear or damages and alert the user of the trend and recommend further inspection. Such continuous, real-time and tailored monitoring of the full close state for each air circuit breaker without having to disrupt the power distribution allows the users to schedule maintenance and inspection as needed and perform remedial actions, if necessary.

In addition, the apparatus 100 can be structured to assist in detecting and identifying a failure mode. For example, where the detectors 110,120 are wired as two separate inputs into the switching device monitor 102, the input from each detectors 110,120 may be used to detect and identify a failure mode. A failure mode includes, e.g., without limitation, a fire-through, shock-out, incomplete close, etc. A fire-through is a condition in which the spring energy is discharged without closing the air circuit breaker 1. In this condition, the discharge detector 110 would return 0, but the pole shaft position detector 120 would return 1, thereby indicating that there is a fire-through failure mode. A shock-out is a condition of immediate opening after closing. That is, after the first contact, within microseconds the air circuit breaker 1 will instantly start to open. In that scenario, both the detectors 110,120 momentarily (microseconds) return 0. If the 0 inputs from the detectors 110,120 last for microseconds only, it can be deduced that a shock-out failure mode has occurred. An incomplete close is a condition in which the circuit breaker 1 is not fully closed. That is, the detectors 110,120 do not return the 0 inputs within the threshold closing time. Detecting and alerting the failure modes at their onset allow the user to make timely corrective actions. It is noted that the example failure modes are provided for illustrative purposes only, and thus the apparatus 100 may detect other failure modes as appropriate without departing from the scope of the disclosed concept.

Furthermore, the apparatus 100 may perform the MCR (making current release) based on the input from the detectors 110,120 without requiring a separate MCR device to be installed within the air circuit breaker 1, thereby reducing manufacturing time and costs.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An apparatus for use in an electrical switching device including an operating mechanism having an energy storage device, a cam assembly, a pole shaft coupled to the cam assembly, and separable contacts coupled to the pole shaft, the apparatus comprising:
a holding device structured to be attached to the operating mechanism of the electrical switching device;
a discharge detector affixed to the holding device and structured to be disposed adjacent to the cam assembly and detect discharging status of the energy storage device based on the position of the cam assembly;
a pole shaft position detector affixed to the holding device and structured to be coupled to the pole shaft and detect open and close state of the separable contacts based on the position of the pole shaft; and
a switching device monitor coupled to the discharge detector and the pole shaft position detector, the switching device monitor structured to receive data from the detectors, analyze the data and perform control and/or diagnostics on the electrical switching device based on the analysis, the data including the detected discharging status of the energy storage device and the detected open and close state of the separable contacts.

2. The apparatus of claim 1, wherein the discharge detector is further structured to measure timing of contact closing and the data includes the measured timing.

3. The apparatus of claim 2, wherein the switching device monitor is further structured to identify a full close state of the separable contacts and measure precise timing of reaching the full close state based on the data.

4. The apparatus of claim 1, wherein the cam assembly includes a charging cam and a drive cam, and wherein the discharge detector is actuated by rotation of the charging cam and the pole shaft position detector is actuated by the pole shaft.

5. The apparatus of claim 4, wherein the discharge detector and the pole shaft position detector are switches connected in parallel, and wherein the discharge detector is closed when the energy storage device is being discharged by rotation of the charging cam and open when the energy storage device is fully discharged and the charging cam has completed the rotation, and wherein the pole shaft position detector is closed when the separable contacts are open via the pole shaft and open when the separable contacts are touching and/or fully closed via the pole shaft.

6. The apparatus of claim 5, wherein:
in an open and charged state of the electrical switching device, the pole shaft position detector is closed and the discharge detector is open;
in an early closing state of the electrical switching device, the pole shaft position detector is closed and the discharge detector is closed;
in the last closing state of the electrical switching device, the pole shaft position detector is open and the discharge detector is closed; or
in a full close state of the electrical switching device, the pole shaft position detector is open and the discharge detector is open.

7. The apparatus of claim 1, wherein the apparatus is further structured to perform MCR (making current release) function.

8. The apparatus of claim 1, wherein the switching device monitor is further structured to alert a user based on the analysis of the data and recommend a preventive measure.

9. The apparatus of claim 1, wherein the switching device monitor is further structured to determine a failure mode based on the data and alert a user about the failure mode.

10. The apparatus of claim 1, wherein the switching device monitor is disposed within an electronic trip unit of the electrical switching device.

11. The apparatus of claim 1, wherein the energy storage device comprises a spring.

12. An electrical switching device structured to connect a power source and loads, comprising:
a housing;
a charging assembly;
an electrical trip unit (ETU) structured to interrupt current from flowing to the loads in an abnormal current condition;
an operating mechanism coupled to the charging handle and the ETU, the operating mechanism including an energy storage device, a cam assembly, a pole shaft coupled to the cam assembly, and separable contacts having a movable contact coupled to the loads and a fixed contact coupled to the power source; and
an apparatus structured to monitor state of the electrical switching device, the apparatus including:
a holding device structured to be attached to the operating mechanism of the electrical switching device;
a discharge detector affixed to the holding device and structured to be disposed adjacent to the cam assembly and detect discharging status of the energy storage device based on position of the cam assembly;
a pole shaft position detector affixed to the holding device and structured to be coupled to the pole shaft and detect open and close state of the separable contacts based on the position of the pole shaft; and
a switching device monitor disposed within the ETU and coupled to the discharge detector and the pole shaft position detector, the switching device monitor structured to receive data from the detectors, analyze the data and perform control and/or health diagnostics of the electrical switching device based on the analysis, the data including the detected discharging status of the energy storage device and the detected open and close state of the separable contacts.

13. The electrical switching device of claim 12, wherein the discharge detector and the pole shaft position detector each comprise microswitches, sensors, or semiconductor devices including optocouplers.

14. A method of protecting an electrical switching device including an operating mechanism having an energy storage device, a cam assembly, a pole shaft coupled to the cam assembly, and separable contacts coupled to the pole shaft, the method comprising:
detecting discharging status of the energy storage device based on position of the cam assembly;
detecting open and close state of the separable contacts based on a position of the pole shaft; and
analyzing data including the detected discharging status of the energy storage device and the detected open and close state of the separable contacts.

15. The method of claim 14, further comprising:
performing diagnostics on the electrical switching device based on the analysis.

16. The method of claim 15, further comprising:
measuring timing of contact closing, wherein the data includes the measured timing.

17. The method of claim 16, further comprising:
identifying a full close state of the separable contacts; and
measuring a precise timing of achieving the full close state based on the data.

18. The method of claim 14, wherein the discharge detector and the pole shaft position detector are switches connected in parallel, and wherein the discharge detector is closed when the energy storage device is discharging by rotation of the charging cam and open when the energy storage device is fully discharged and the charging cam has completed the rotation, and wherein the pole shaft position detector is closed when the separable contacts are open via the pole shaft and open when the separable contacts are touching and/or fully closed via the pole shaft.

19. The method of claim 18, wherein:
in an open and charged state of the electrical switching device, the pole shaft position detector is closed and the discharge detector is open;
in an early closing state of the electrical switching device, the pole shaft position detector is closed and the discharge detector is closed;
in the last closing state of the electrical switching device, the pole shaft position detector is open and the discharge detector is closed; or
in a full close state the electrical switching device, the pole shaft position detector is open and the discharge detector is open.

20. The method of claim 14, further comprising:
performing MCR (making current release) function based on the analysis.
